(19) United States
(12) Patent Application Publication
(10) Pub. No.: US 2023/0325628 A1
(43) Pub. Date: Oct. 12, 2023

(54) CAUSAL EXPLANATION OF ATTENTION-BASED NEURAL NETWORK OUTPUT

(71) Applicants: Shami Nisimov, New-ziv Z (IL); Raanan Yonatan Yehezkel Rohekar, Tel Aviv (IL); Yaniv Gurwicz, Tel Aviv (IL); Guy Koren, Haifa (IL); Gal Novik, Tel Aviv (IL)

(72) Inventors: Shami Nisimov, New-ziv Z (IL); Raanan Yonatan Yehezkel Rohekar, Tel Aviv (IL); Yaniv Gurwicz, Tel Aviv (IL); Guy Koren, Haifa (IL); Gal Novik, Tel Aviv (IL)

(21) Appl. No.: 18/325,267

(22) Filed: May 30, 2023

Related U.S. Application Data
(60) Provisional application No. 63/375,825, filed on Sep. 15, 2022.

(51) Int. Cl. G06N 3/02

(52) U.S. Cl. CPC G06N 3/02

(57) ABSTRACT

Causal explanations of outputs of a neural network can be learned from an attention layer in the neural network. The neural network may compute an output variable by processing a variable set including one or more input variables. An attention matrix may be computed by the attention layer in an abductive inference for which a new variable set including the input variables and the output variable is input into the neural network. Causal relationship between the variables in the new variable set may be determined based on the attention matrix and illustrated in a causal graph. A tree structure may be generated based on the causal graph. An input variable may be identified using the tree structure and determined to be the reason why the neural network computed the output variable. An explanation of the causal relation between the input variable and output variable can be generated and provided.

### CROSS REFERENCE TO RELATED APPLICATION

This application claims the benefit of U.S. Provisional Pat. Application No. 63/375,825, filed Sep. 15, 2022, which is incorporated by reference in its entirety.

### TECHNICAL FIELD

This disclosure relates generally to neural networks, and more specifically, causal explanations of attention-based neural network outputs.

### BACKGROUND

The last decade has witnessed a rapid rise in AI (artificial intelligence) based data processing, particularly based on neural networks (also referred to as “deep neural network (DNN)”). DNNs, due to their ability to achieve beyond human-level accuracy, are widely used in the domains of recommendation, computer vision, speech recognition, image, video processing, and so on. The significant improvements in DNN model size and accuracy coupled with the rapid increase in computing power of execution platforms have led to the adoption of DNN applications even within resource constrained mobile and edge devices that have limited energy availability.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example, and not by way of limitation, in the figures of the accompanying drawings.

Figure FIG. 1 illustrates an AI environment, in accordance with various embodiments.

FIG. 2 is a block diagram of a neural network system including a causal explanation module, in accordance with various embodiments.

FIG. 3 illustrates an example inference of a neural network, in accordance with various embodiments.

FIG. 4 illustrates an example abductive inference of the neural network, in accordance with various embodiments.

FIG. 5 illustrates an example causal graph, in accordance with various embodiments.

FIG. 6 illustrates an example tree structure, in accordance with various embodiments.

FIGS. 7A-7C illustrate example potentially influencing sets, in accordance with various embodiments.

FIG. 8 illustrates an example explanation for an output of a pretrained neural network, in accordance with various embodiments.

FIG. 9 is a flowchart showing a method of learning causal relationships, in accordance with various embodiments.

FIG. 10 is a block diagram of an example computing device, in accordance with various embodiments.

### DETAILED DESCRIPTION

### Overview

For many tasks performed by DNNs, it can be helpful or even necessary to provide explanations of DNN outputs, such as explanations indicating the reason why the DNN made such outputs given the inputs. In a case where an automated system uses a neural network to provide recommendations to humans, an explanation to why a specific recommendation was given to a human in a tangible way can lead to greater trust and greater human engagement with the automated system. Recommenders based on DNNs, such as attention-based DNNs, have demonstrated the ability to achieve beyond human-level accuracy. However, it is unclear how to extract explanations meaningful for humans from these recommenders. For instance, it is unclear how the recommender modeled the human decision process according to which the recommendation was provided.

In an example, a human decision process for selecting which item to interact with (e.g., which movie to watch, which phone to purchase, etc.), consists of multiple decision pathways that may diverge and merge over time. Moreover, they may be influenced by latent confounders (e.g., user intent, etc.) along this process. It has been a challenge to aim at recovering this complex process. Many currently available neural networks fail to reason about questions like “why...?”, “what if the user will interact with...?” (interventional), “what would have been recommended had the user interacted differently?” (counterfactual), and so on. These neural networks lack such reasoning capabilities.

A solution is to use attention matrices, which can be computed within neural networks as part of the inference process to learn about input-output relations for providing explanations. However, this solution has been shown to be erroneous in the general case, as attention cannot be used for reliable explanation in general. Also, this solution cannot learn a causal graph, thereby providing a narrow view that limits the range of “why” questions that can be answered (e.g., they are usually incomplete). Further, this solution heavily relies on the assumption that inputs (e.g., session of user-item interactions) having high attention values are better explanation for the output (e.g., recommendation). Given such an assumption, the solution considers marginal statistical dependence but ignores conditional independence relations. Therefore, improved technologies for causal relation of DNN input and output are needed.

Embodiments of the present disclosure may improve on at least some of the challenges and issues described above by using attention mechanisms to learn the causal relation between neural network input and output. In an example, a neural network may receive and process an input dataset (e.g., a dataset including one or more input variables) to compute an output. A causal graph can be learned based on one or more attention matrices computed by one or more attention layers in the neural network in an abductive inference process. The causal graph may represent the causal relationships between the one or more input variables and the output. A causal explanation (e.g., counterfactual explanation, etc.) for the output of the neural network may be constructed from the causal graph.

In various embodiments of the present disclosure, a variable set is input into a pretrained neural network. The variable set includes one or more variables. A variable may encode an event, measurement, or content that can be analyzed by the pretrained neural network. Examples of events may include actions (e.g., actions of people, organizations, machines, vehicles, animals, etc.), natural events, social events, and so on. Examples of measurements may include measurements made by people, devices (e.g., sensors, etc.), and so on. Content may be text, audio, image, video, other types of content, or some combination thereof. The pretrained neural network may output the result of the analysis on the variable set. One or more variables in the variable set may have a causal relation with the output of the pretrained neural network, and the causal relation can be revealed by a causal graph.

For the purpose of illustration, some descriptions hereinafter use variables encoding user actions as examples. For instance, a variable may correspond to a historical user action (e.g., a historical interaction of the user with an item) and includes information about the historical user action. The pretrained neural network may output a new variable based on the variable set. The new variable may indicate a predicted user action. The predicted user action may correspond to a recommendation made by the pretrained neural network. For instance, the predicted user action may be a predicted interaction of the user with an item, and the neural network provides a recommendation for the item to the user. The pretrained neural network may output multiple predicted user actions, which may be ranked based on likelihoods of the user performing these actions. The recommendation by the neural network may be based on the predicted user action that is highest ranked.

The variable set may be referred to as an incomplete variable set, versus a set including the variable set plus the new variable may be referred to as a complete variable set. An abductive inference process may be conducted by inputting the complete variable set into the pretrained neural network. The pretrained neural network includes at least one attention layer that process data with attention mechanisms. One or more attention matrices computed by the attention layer(s) in the abductive inference process may be extracted. Conditional independence between the variables in the complete variable set may be measured based on the one or more attention matrices. A causal graph can then be generated based on the conditional independence. The causal graph includes the new variable, which is connected to at least one variable in the incomplete variable set. Some variables in the incomplete variable set may be connected to each other. A connection in the causal graph indicates a dependence or causal relation.

The causal graph may be converted to a tree structure, where the new variable is the root of the tree, and the other variables are leaves. A distance between the new variable and each of the other variables may be determined based on the corresponding connection(s) in the causal graph. A search for an explanation why the new variable was generated can be performed based on the tree structure. For instance, a variable in the incomplete variable set is identified as the cause why the new variable was generated by the pretrained neural network. The identified variable may be removed from the incomplete variable set to form a new input dataset, based on which the pretrained neural network can compute a different output. Further, a causal explanation for the input-output relation of the pretrained neural network is generated. The causal explanation may indicate that the user action represented by identified variable is the reason for the initial output of the pretrained neural network. The causal explanation may further indicate that the neural network would have made the different output if the user action represented by identified variable was not performed.

The present disclosure provides a causal explanation platform for learning session- or user- specific causal models from pretrained neural networks. The causal models (an example of which is the causal graph described above) can be specific to the variable set as the abductive inference process can be specific to the variable set. The variable set may be specific to a session or a user. For instance, the variable(s) in the variable set may represent user actions from the same session or actions performed by the same user. As the causal models are learned based on the attention layer(s) in the pretrained neural network, the causal explanation platform can be integrated with the pretrained neural network, and retraining or training another model can be avoided. The causal explanation platform can run efficiently on various types of processing units, such as central processing unit (CUP), graphical processing unit (GPU), and so on. Compared with the currently available solutions for explaining causation relation of neural network input and output, the present disclosure provides a more advantageous solution.

For purposes of explanation, specific numbers, materials and configurations are set forth in order to provide a thorough understanding of the illustrative implementations. However, it will be apparent to one skilled in the art that the present disclosure may be practiced without the specific details or/and that the present disclosure may be practiced with only some of the described aspects. In other instances, well known features are omitted or simplified in order not to obscure the illustrative implementations.

Further, references are made to the accompanying drawings that form a part hereof, and in which is shown, by way of illustration, embodiments that may be practiced. It is to be understood that other embodiments may be utilized, and structural or logical changes may be made without departing from the scope of the present disclosure. Therefore, the following detailed description is not to be taken in a limiting sense.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order from the described embodiment. Various additional operations may be performed or described operations may be omitted in additional embodiments.

For the purposes of the present disclosure, the phrase “A and/or B” or the phrase “A or B” means (A), (B), or (A and B). For the purposes of the present disclosure, the phrase “A, B, and/or C” or the phrase “A, B, or C” means (A), (B), (C), (A and B), (A and C), (B and C), or (A, B, and C). The term “between,” when used with reference to measurement ranges, is inclusive of the ends of the measurement ranges.

The description uses the phrases “in an embodiment” or “in embodiments,” which may each refer to one or more of the same or different embodiments. The terms “comprising,” “including,” “having,” and the like, as used with respect to embodiments of the present disclosure, are synonymous. The disclosure may use perspective-based descriptions such as “above,” “below,” “top,” “bottom,” and “side” to explain various features of the drawings, but these terms are simply for ease of discussion, and do not imply a desired or required orientation. The accompanying drawings are not necessarily drawn to scale. Unless otherwise specified, the use of the ordinal adjectives “first,” “second,” and “third,” etc., to describe a common object, merely indicates that different instances of like objects are being referred to and are not intended to imply that the objects so described must be in a given sequence, either temporally, spatially, in ranking or in any other manner.

In the following detailed description, various aspects of the illustrative implementations will be described using terms commonly employed by those skilled in the art to convey the substance of their work to others skilled in the art.

The terms “substantially,” “close,” “approximately,” “near,” and “about,” generally refer to being within +/-20% of a target value based on the input operand of a particular value as described herein or as known in the art. Similarly, terms indicating orientation of various elements, e.g., “coplanar,” “perpendicular,” “orthogonal,” “parallel,” or any other angle between the elements, generally refer to being within +/- 5-20% of a target value based on the input operand of a particular value as described herein or as known in the art.

In addition, the terms “comprise,” “comprising,” “include,” “including,” “have,” “having” or any other variation thereof, are intended to cover a non-exclusive inclusion. For example, a method, process, device, or system that comprises a list of elements is not necessarily limited to only those elements but may include other elements not expressly listed or inherent to such method, process, device, or systems. Also, the term “or” refers to an inclusive “or” and not to an exclusive “or.”

The systems, methods and devices of this disclosure each have several innovative aspects, no single one of which is solely responsible for all desirable attributes disclosed herein. Details of one or more implementations of the subject matter described in this specification are set forth in the description below and the accompanying drawings.

### Example AI Environment

FIG. 1 illustrates an AI environment 100, in accordance with various embodiments. The AI environment 100 includes a neural network system 110, a plurality of user devices 120 (individually referred to as user device 120), and a third-party system 130, which are in communication through a network 105. In other embodiments, the AI environment 100 may include fewer, more, or different components. For instance, the AI environment 100 may a different number of neural network system 110, user device 120, or third-party system 130. Functionality attributed to a component of the AI environment 100 may be accomplished by a different component included in the AI environment 100 or by a different device or system. For instance, the neural network system 110 may be part of a user device 120 or the third-party system 130.

The neural network system 110 provides DNNs that can be used to perform various AI tasks, such as recommendation, prediction, image classification, visual reconstruction, augmented reality, robot localization and navigation, medical diagnosis, weather prediction, and so on. The neural network system 110 may train a DNN based on a request from the third-party system 130. For instance, the neural network system 110 may receive information about a task from the third-party system 130. The neural network system 110 may generate and train a DNN model based on the information. In some embodiments, the neural network system 110 may also receive data from the third-party system 130 that the neural network system 110 can input into the DNN. The neural network system 110 may provide the output of the DNN model to the third-party system 130 or the user devices 120. In other embodiments, the neural network system 110 may provide the DNN model to the third-party system 130 or the user devices 120 so that inference of the DNN model can be conducted by the third-party system 130 or the user devices 120. In some embodiments, the neural network system 110 may compress the DNN model based on computational and communication resources available at the third-party system 130 or the user devices 120 and provide a compressed version of the DNN model to the third-party system 130 or the user devices 120.

The neural network system 110 also provides causal explanations of outputs of neural networks. A causal explanation may describe a causal relation between an input and the corresponding output of a neural network. In some embodiments, the neural network system 110 generates neural networks including attention layers and uses the attention layers to learn causal explanations of outputs of the neural networks. The neural network system 110 may perform two inference processes for a neural network to generate a causal explanation.

For the first inference process, the neural network receives an input dataset that includes one or more input elements. An input element may be a variable. The neural network processes the input dataset and computes an output variable. In some embodiments, the neural network may generate multiple output variables. The neural network may rank the output variables, e.g., based on confidences of the neural network for the output variables. The output variable that is ranked highest may be considered as the final output of the neural network.

After the first inference process, the neural network system 110 may perform a second inference process, which may be an abductive inference process. For the second inference process, the neural network system 110 forms a new input dataset that includes the input dataset of the first inference process and the output variable of the first inference process. The neural network receives and processes the new input dataset. One or more attention layers in the neural network may each compute an attention matrix.

The neural network system 110 may further determine causal relationships between the input and output variables based on the one or more attention matrices computed by the one or more attention layers. In some embodiments, the neural network system 110 may measure conditional independence between the input and output variables based on the attention matrices. The neural network system 110 may further build a causal graph based on the condition independence measures. The causal graph includes nodes, each of which represents an input variable or output variable. At least some of the nodes are connected. A connection of two nodes indicates a causal relationship between the two variables represented by the two nodes.

The neural network system 110 may further build a tree structure that illustrates potential influence among the input and output variables. The tree structure is also referred to as a PI-tree structure. The output variable may be the root of the tree structure, and the input variables may be the leaves of the tree structure. Different leaves may be arranged at different distances from the root. The distances may be determined based on the causal relationships. The neural network system 110 may use the tree structure to perform a search for identifying one or more input variables that constitute a minimal explaining set. The neural network system 110 may generate a causal explanation of the output variable based on the identified input variable(s). In some embodiments, the neural network system 110 may generate an explanation that indicates that the neural network would have computed a different output but for the identified input variable(s).

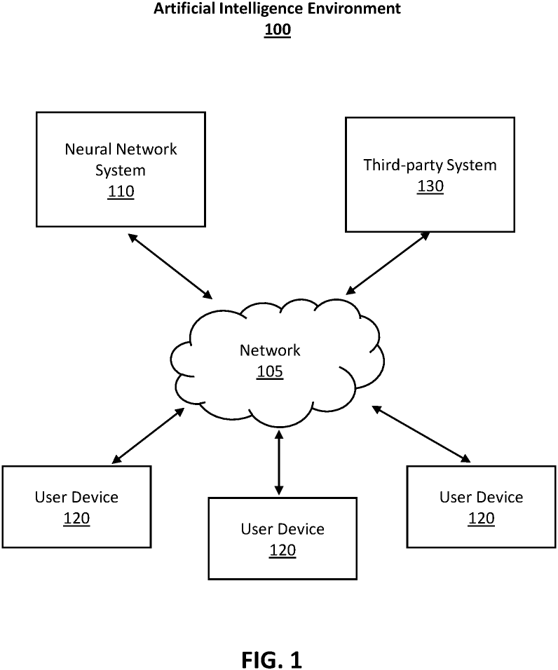

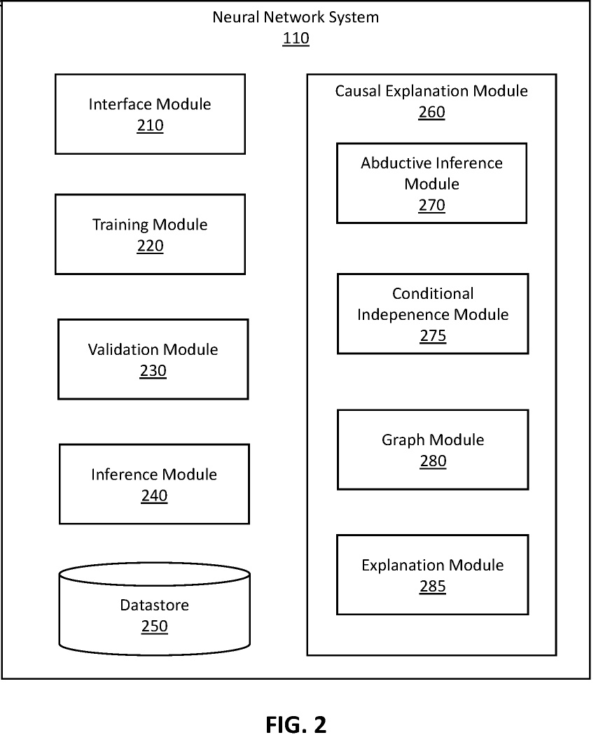

The neural network system 110 may provide the causal explanation for display to the user. For instance, the neural network system 110 may transmit the causal explanation to the user device 120 and the user device 120 can display the causal explanation to the user. Additionally or alternatively, the neural network system 110 may provide the causal explanation to the third-party system 130. Certain aspects of the neural network system 110 are provided below in conjunction with FIG. 2.

The third-party system 130 is coupled to the network 105 for communicating with the neural network system 110 and the user devices 120. In one embodiment, the third-party system 130 provides content (e.g., image, video, audio, text, etc.) that users can interact with through the user devices 120. In one embodiment, the third-party system 130 is an application provider communicating information describing applications for execution by a user device 120 or communicating data to user devices 120 for use by an application executing on the client device. In other embodiments, the third-party system 130 provides content or other information for presentation via a user device 120. The third-party system 130 may also communicate information to the neural network system 110, such as information about AI tasks, causal explanations of neural network outputs, and so on.

A user device 120 may be one or more computing devices capable of receiving user input as well as transmitting and/or receiving data via the network 105. In one embodiment, a user device 120 is a conventional computer system, such as a desktop or a laptop computer. Alternatively, a user device 120 may be a device having computer functionality, such as a personal digital assistant (PDA), a mobile telephone, a smartphone, an autonomous vehicle, or another suitable device. A user device 120 is configured to communicate via the network 105. In one embodiment, a user device 120 executes an application allowing a user of the user device 120 to interact with the neural network system 110 or the third-party system 130. In some embodiments, the user device 120 may execute a browser application to enable interaction between the user device 120 and the neural network system 110 or the third-party system 130 via the network 105. In another embodiment, a user device 120 interacts with the neural network system 110 or the third-party system 130 through an application programming interface (API) running on a native operating system of the user device 120, such as IOS® or ANDROlD™. For instance, the user device 120 can enable the user to interact with items posted on a website or application maintained by the third-party system. The user may be able to view, comment on, purchase, or perform other types of actions on the item.

In an embodiment, a user device 120 is an integrated computing device that operates as a standalone network-enabled device. For example, the user device 120 includes display, speakers, microphone, camera, and input device. In another embodiment, a user device 120 is a computing device for coupling to an external media device such as a television or other external display and/or audio output system. In this embodiment, the user device 120 may couple to the external media device via a wireless interface or wired interface (e.g., an HDMI (High-Definition Multimedia Interface) cable) and may utilize various functions of the external media device such as its display, speakers, microphone, camera, and input devices. Here, the user device 120 may be configured to be compatible with a generic external media device that does not have specialized software, firmware, or hardware specifically for interacting with the user device 120.

The network 105 supports communications between the neural network system 110, user devices 120, and third-party system 130. The network 105 may comprise any combination of local area and/or wide area networks, using both wired and/or wireless communication systems. In one embodiment, the network 105 may use standard communications technologies and/or protocols. For example, the network 105 may include communication links using technologies such as Ethernet, 8010.11, worldwide interoperability for microwave access (WiMAX), 3G, 4G, code division multiple access (CDMA), digital subscriber line (DSL), etc. Examples of networking protocols used for communicating via the network 105 may include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 105 may be represented using any suitable format, such as hypertext markup language (HTML) or extensible markup language (XML). In some embodiments, all or some of the communication links of the network 105 may be encrypted using any suitable technique or techniques.

### Example Neural Network System With Causal Explanation Module

FIG. 2 is a block diagram of a neural network system 110 including a causal explanation module 260, in accordance with various embodiments. As described above, the neural network system 110 can provide DNNs that can be used in various AI applications. The neural network system also provides causal explanations of DNN outputs. As shown in FIG. 2, the neural network system 110 also includes an interface module 210, a training module 220, a validation module 230, an inference module 240, and a datastore 250. In other embodiments, alternative configurations, different or additional components may be included in the neural network system 110. Further, functionality attributed to a component of the neural network system 110 may be accomplished by a different component included in the neural network system 110 or a different system. For instance, the inference module 240 or causal explanation module 260 may be in a user device 120, the third-party system 130, or a different device or system.

The interface module 210 facilitates communications of the neural network system 110 with other systems. For example, the interface module 210 establishes communications between the neural network system 110 with an external device or system (e.g., the user devices 120, third-party system 130, etc.) to receive data that can be used to train DNNs or input into DNNs to perform tasks. As another example, the interface module 210 supports the neural network system 110 to distribute DNNs to other systems, e.g., computing devices configured to apply DNNs to perform tasks. The interface module 210 can also facilitate transmission of causal explanations of DNN outputs to an external device or system (e.g., the user devices 120, third-party system 130, etc.).

The training module 220 trains DNNs. In some embodiments, the training module 220 trains a DNN using a training dataset. The training module 220 forms the training dataset. In an example where the training module 220 trains an DNN to recognize objects in images, the training dataset includes training images and training labels. The training labels describe ground-truth classifications of objects in the training images. In some embodiments, each label in the training dataset corresponds to an object in a training image. In some embodiments, a part of the training dataset may be used to initially train the DNN, and the rest of the training dataset may be held back as a validation subset used by the validation module 230 to validate performance of a trained DNN. The portion of the training dataset not including the tuning subset and the validation subset may be used to train the DNN.

The training module 220 also determines hyperparameters for training the DNN. Hyperparameters are variables specifying the DNN training process. Hyperparameters are different from parameters inside the DNN (e.g., weights of filters). In some embodiments, hyperparameters include variables determining the architecture of the DNN, such as number of hidden layers, etc. Hyperparameters also include variables which determine how the DNN is trained, such as batch size, number of epochs, etc. A batch size defines the number of training samples to work through before updating the parameters of the DNN. The batch size is the same as or smaller than the number of samples in the training dataset. The training dataset can be divided into one or more batches. The number of epochs defines how many times the entire training dataset is passed forward and backwards through the entire network. The number of epochs defines the number of times that the deep learning algorithm works through the entire training dataset. One epoch means that each training sample in the training dataset has had an opportunity to update the parameters inside the DNN. An epoch may include one or more batches. The number of epochs may be 2, 20, 500, 200, or even larger.

The training module 220 defines the architecture of the DNN, e.g., based on some of the hyperparameters. The architecture of the DNN includes an input layer, an output layer, and a plurality of hidden layers. In some embodiments, the hidden layers include one or more attention layers. An attention layer may process data with an attention mechanism, such as a mechanism that can help the DNN to memorize long or large input data by enhancing some parts (e.g., the relatively more important parts) of the input data while diminishing other parts (e.g., the relatively less important parts). The DNN can learn which part of the input data is more important in the training process, e.g., through gradient descent. An attention layer may compute an attention matrix based on internal parameters of the attention layer, and values of the internal parameters can be determined during the training process.

The input layer of an DNN may include tensors (e.g., a multidimensional array) specifying attributes of the input image, such as the height of the input image, the width of the input image, and the depth of the input image (e.g., the number of bits specifying the color of a pixel in the input image). The output layer includes labels of objects in the input layer. The hidden layers are layers between the input layer and output layer. The hidden layers include one or more convolutional layers and one or more other types of layers, such as pooling layers, fully connected layers, normalization layers, softmax or logistic layers, and so on. The convolutional layers of the DNN abstract the input image to a feature map that is represented by a tensor specifying the feature map height, the feature map width, and the feature map channels (e.g., red, green, blue images include three channels). A pooling layer is used to reduce the spatial volume of input image after convolution. It is used between two convolution layers. A fully connected layer involves weights, biases, and neurons. It connects neurons in one layer to neurons in another layer. It is used to classify images between different category by training.

In the process of defining the architecture of the DNN, the training module 220 also adds an activation function to a hidden layer or the output layer. An activation function of a layer transforms the weighted sum of the input of the layer to an output of the layer. The activation function may be, for example, a rectified linear unit activation function, a tangent activation function, or other types of activation functions.

After the training module 220 defines the architecture of the DNN, the training module 220 inputs a training dataset into the DNN. The training dataset includes a plurality of training samples. An example of a training sample includes an object in an image and a ground-truth label of the object. The training module 220 modifies the parameters inside the DNN (“internal parameters of the DNN”) to minimize the error between labels of the training objects that are generated by the DNN and the ground-truth labels of the objects. The internal parameters include weights of filters in the convolutional layers of the DNN. In some embodiments, the training module 220 uses a cost function to minimize the error.

The training module 220 may train the DNN for a predetermined number of epochs. The number of epochs is a hyperparameter that defines the number of times that the deep learning algorithm will work through the entire training dataset. One epoch means that each sample in the training dataset has had an opportunity to update internal parameters of the DNN. After the training module 220 finishes the predetermined number of epochs, the training module 220 may stop updating the parameters in the DNN. The DNN having the updated parameters is referred to as a trained DNN.

The validation module 230 verifies accuracy of trained DNNs. In some embodiments, the validation module 230 inputs samples in a validation dataset into a trained DNN and uses the outputs of the DNN to determine the model accuracy. In some embodiments, a validation dataset may be formed of some or all the samples in the training dataset. Additionally or alternatively, the validation dataset includes additional samples, other than those in the training sets. In some embodiments, the validation module 230 may determine an accuracy score measuring the precision, recall, or a combination of precision and recall of the DNN. The validation module 230 may use the following metrics to determine the accuracy score: Precision = TP / (TP + FP) and Recall = TP / (TP + FN), where precision may be how many the reference classification model correctly predicted (TP or true positives) out of the total it predicted (TP + FP or false positives), and recall may be how many the reference classification model correctly predicted (TP) out of the total number of objects that did have the property in question (TP + FN or false negatives). The F-score (F-score = 2 * PR / (P + R)) unifies precision and recall into a single measure.

The validation module 230 may compare the accuracy score with a threshold score. In an example where the validation module 230 determines that the accuracy score of the augmented model is lower than the threshold score, the validation module 230 instructs the training module 220 to re-train the DNN. In one embodiment, the training module 220 may iteratively re-train the DNN until the occurrence of a stopping condition, such as the accuracy measurement indication that the DNN may be sufficiently accurate, or a number of training rounds having taken place.

The inference module 240 applies the trained or validated DNN to perform tasks. The inference module 240 may obtain an input dataset for a DNN that includes one or more input variables. The input dataset may be received from the user devices 120 or the third-party system 130. In some embodiments, the inference module 240 may receive data from different sources and may combine the data to generate the input dataset. For example, the inference module 240 may receive information of different users from different user devices 120. As another example, the inference module 240 may receive data from one or more user devices 120 and the third-party system 130. The inference module 240 inputs the input dataset into the DNN. The DNN processes the input dataset and computes one or more output variables.

In some cases where a DNN is trained to provide recommendations of items to users, an input variable may represent a historical user interaction with an item, such as an interaction of the user with an item in association with the third-party system 130 that was performed through a user device 120 associated with the user. The input dataset may correspond to a specific session (e.g., a specific time window, etc.), a specific type of item, a specific user, and so on. An output variable may indicate an interaction of an item that is predicted by the DNN, and the DNN may make a recommendation of the item based on the prediction. In some embodiments, the DNN may generate multiple output variables and rank the output variables, e.g., based on confidences of the DNN for the output variables. The output variable that is ranked highest may be considered as the final output of the DNN. The different output variables may correspond to different recommendations of the DNN, and a recommendation that is ranked highest may be considered as the top recommendation and be provided to the user associated with a user device 120 or a third-party associated with the third-party system 130.

In some cases where a DNN is trained to classify images, the inference module 240 inputs images into the DNN. The DNN outputs classifications of objects in the images. As an example, the DNN may be provisioned in a security setting to detect malicious or hazardous objects in images captured by security cameras. As another example, the DNN may be provisioned to detect objects (e.g., road signs, hazards, humans, pets, etc.) in images captured by cameras of an autonomous vehicle. The input to the DNN may be formatted according to a predefined input structure mirroring the way that the training dataset was provided to the DNN. The DNN may generate an output structure which may be, for example, a classification of the image, a listing of detected objects, a boundary of detected objects, or the like. In some embodiments, the inference module 240 distributes the DNN to other systems, e.g., computing devices in communication with the neural network system 110, for the other systems to apply the DNN to perform the tasks.

The datastore 250 stores data received, generated, used, or otherwise associated with the neural network system 110. For example, the datastore 250 stores the datasets used by the training module 220 and validation module 230. The datastore 250 may also store data generated by the training module 220 and validation module 230, such as the hyperparameters for training DNNs, internal parameters of trained DNNs (e.g., values of tunable parameters of activation functions, such as Fractional Adaptive Linear Units (FALUs)), and so on. The datastore 250 may further store data generated by the causal explanation module 260, such as causal graphs, tree structures, causal explanations, and so on. In the embodiment of FIG. 2, the datastore 250 is a component of the neural network system 110. In other embodiments, the datastore 250 may be external to the neural network system 110 and communicate with the neural network system 110 through a network.

The causal explanation module 260 learns causal explanations of DNN outputs based on attention layers in the DNNs. The causal explanation module 260 includes an abductive inference module 270, a conditional independence module 275, a graph module 280, and an explanation module 285. In other embodiments, alternative configurations, different or additional components may be included in the neural network system 110. Further, functionality attributed to a component of the neural network system 110 may be accomplished by a different component included in the neural network system 110 or a different system.

The abductive inference module 270 runs abductive inference processes for obtaining information that can be used by other components of the causal explanation module 260 to determine DNN input-output causal relations. The abductive inference module 270 may perform an abductive inference process after an inference process performed by the inference module 240. In some embodiments, the abductive inference module 270 receives an output of a DNN from the inference module 240. The abductive inference module 270 may also receive the input to the DNN with which the DNN computes the output. The abductive inference module 270 may generate an abductive input dataset that includes both the input dataset and the output of the DNN for the inference performed by the inference module 240. In some embodiments, the abductive input dataset is considered as a complete dataset, versus the input dataset is considered as an incomplete dataset as it does not include the output.

The abductive inference module 270 may further start the abductive inference process by inputting the complete dataset into the DNN. Layers in the DNN, including the attention layer(s) in the DNN, process the complete dataset based on their internal parameters. The abductive inference module 270 extracts outputs of the attention layer(s) in the DNN. An output of an attention layer is an attention tensor. A tensor is a data structure having multiple elements across one or more dimensions. Example tensors include a vector, which is a one-dimensional tensor, and a matrix, which is a two-dimensional tensor. There can also be three-dimensional tensors and even higher dimensional tensors. An attention tensor, in some embodiments, may be an attention matrix that includes attention elements arranged in rows and columns. In some embodiments, the abductive inference module 270 may extract a single attention tensor. For example, the DNN may include a single attention layer, and the abductive inference module 270 extracts the output of the attention layer. As another example, the DNN may include multiple attention layers, and the abductive inference module 270 extracts the output of the last attention layer of the DNN. The last attention layer of the DNN is the attention layer that is arranged after any other attention layers in the DNN. In other embodiments, the abductive inference module 270 may extract multiple attention tensors. For example, the abductive inference module 270 may extract an attention tensor from every attention matrix. The number of the extracted attention tensors may equal the number of attention layers in the DNN. As another example, the abductive inference module 270 may select a subset of the attention layers in the DNN and extracts the outputs of the selected attention layers. The abductive inference module 270 may provide the extract attention tensor(s) to the conditional independence module 275 for further processing.

The conditional independence module 275 measures condition independences of variables in the abductive input dataset based on the attention tensor(s) from the abductive inference module 270. A decision process, e.g., a process for selecting which items to interact with, may include multiple decision pathways that could diverge and merge over time. The decision pathways may be influenced by a combination of observed variables and latent variables. Observed variables are the variables in the abductive input dataset. Latent variables may represent unmeasured influences on the user’s decision to interact with a specific item. Examples of unmeasured influences may include user intent, previous recommendation slates presented to the user, and so on.

In some embodiments, the conditional independence module 275 may use one or more causal discovery algorithms to test conditional independence between variables. For instance, the conditional independence module 275 may use partial-correlation conditional independence testing after evaluating the correlation matrix from the attention matrix. The conditional independence module 275 may map the variables to a reproducing kernel Hilbert space (RKHS). In an embodiment, a single attention tensor A is used to represents functions in the RKHS. The conditional independence module 275 may compute covariance tensor K based on the attention matrix:

$$K = A ⋅ {A}^{\text{T}}$$

In embodiments where the attention tensor A is an attention matrix, the covariance tensor K may be a covariance matrix.

In other embodiments, the conditional independence module 275 may multiple attention tensors from the abductive inference module 270 and may compute a covariance tensor based on the attention tensors. In an embodiment where there are N number of attention tensors, the conditional independence module 275 may compute a covariance tensor using a different equation:

$$K = \left({A}_{1} ⋅ {A}_{2} ⋯ {A}_{N}\right) ⋅ \left({A}_{N}^{T} ⋅ {A}_{N - 1}^{T} ⋯ {A}_{1}\right)$$

In another embodiment, the conditional independence module 275 may perform an element-wise aggregation on the attention tensors to generate a single aggregated attention tensor. Each element in the aggregated attention tensor is a result of aggregating a corresponding element from each of the attention tensors. The position of the element in the aggregated attention tensor may be the same as the position of each corresponding element in the attention tensor. The aggregation may be accumulation, weighted accumulation, averaging, weighted averaging, and so on. In embodiments where weighted accumulation or weighted averaging is used, the conditional independence module 275 assign a weight to each attention layer based on one or more attributes of the attention layer, e.g., the position of the attention layer in the DNN, the size (e.g., the number of internal parameters, etc.) of the attention layer, and so on. The conditional independence module 275 may use the weights of the attention layers as weights of their output tensors to compute the aggregated attention tensor. Then the conditional independence module 275 may use the first equation to compute the covariance tensor based on the aggregated attention tensor.

The conditional independence module 275 may further use the covariance K to compute correlation coefficients that indicates causal relationships between any two variables:

$${ρ}_{i j} = {K}_{i j} / \sqrt{{K}_{i i} ⋅ {K}_{j j}} .$$

where ρ_{ĳ} is a correlation coefficient for two variables, i denotes a row or column index position, and j denotes a column or row index position. The correlation coefficient ρ_{ĳ} may indicate a measure of the conditional dependence (or conditional independence) of one of the two variables from the other variable. The potential influence may be a causal relationship.

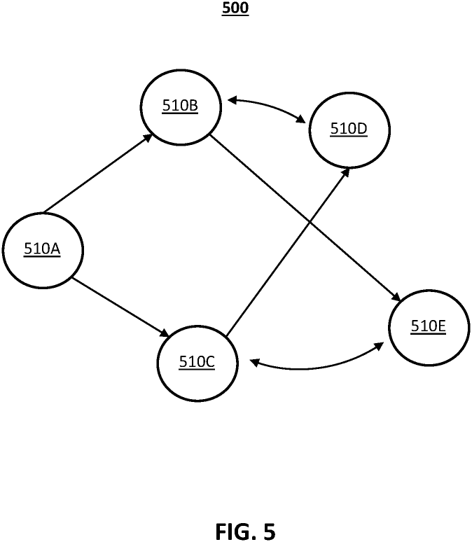

The graph module 280 generates a causal graph based on conditional independence measures determined by the conditional independence module 275. The graph module 280 may generate a node for each of the variables in the abductive input dataset. Some of the nodes may be connected in the causal graph. The graph module 280 may connect two or more nodes based on the conditional independence measure between the variables represented by the nodes. The causal graph may be specific to the input dataset that was used by the DNN to compute the output. In some embodiments, a connection may be from one node to another node. In other embodiments, a connection may be bidirectional. The causal graph may be an ancestral graph, e.g., a partial ancestral graph. An example causal graph is shown in FIG. 5.

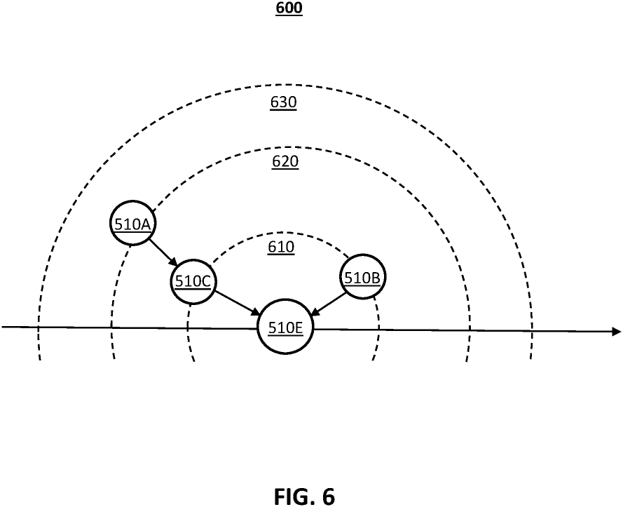

The graph module 280 may further generate a tree structure based on the causal graph. The graph module 280 may place the node representing the output variable as the root of the tree. The input variables may be used as leaves of the tree. The graph module 280 may place the leaves in the tree structure based on the connections between the nodes in the causal graph. The tree structure may have a hierarchy. In an example, the graph module 280 may define one or more circles around the root node. The root node may be at the center of the circles. The graph module 280 may place one or more nodes that are directly connected to the root node at the periphery of the circle having the smallest radius. These nodes are in the first tier. The graph module 280 may place one or more other nodes that are directly connected to a node in the first tier at the periphery of the circle having the second smallest radius. These nodes are in the second tier. The graph module 280 may repeat this process till all the nodes that are directly or indirectly connected to the root node in the causal graph are placed. The tree structure also illustrates the connections between the nodes. For instance, a node in a tier is connected to a node in the next tier. An example tree structure is shown in FIG. 6.

In some embodiments, connections between nodes in a causal graph constitute one or more paths that represent potential influences of the input variables on the output variable. Such paths are also referred to as potential influence paths. A potential influence path in the causal graph may be a path Π(A,Z) = 〈A...,Z〉, where each letter denotes a node, such that for every sub-path 〈U, V, W〉 of Π(A, Z), where there are connections towards V and there is no edge between U and W in the tree structure. A potential influence path may ensure dependence between its two end points when conditioned on every node on the path. A single edge may be a potential influence path. The tree structure may be rooted at A. There may be a path from A to Z in the tree structure when there is a potential influence path 〈A, V₁,...Vₖ, Z〉 in the causal graph. The tree structure may include all potential influence paths originating from the root.

The explanation module 285 generates causal explanations for DNN outputs based on tree structures from the graph module 280. In some embodiments, the explanation module 285 searches for a minimal explaining set for a DNN output in the corresponding tree structure. The minimal explaining set may include one or more input variables that potentially influenced the output variable and can be considered as the reason why the DNN provides the output. The explanation module 285 may identify potentially influencing sets on the root node in the tree structure. In some embodiments, a potentially influencing set E satisfies the following criteria:

$$\left|E\right| = r ;$$

∀E ∈ E there exists a potential influence path Π(A, E) such that ∀V ∈ Π(A,E),V ∈ E; and ∀E ∈ E, E temporally precedes A.A potentially influencing set may not necessarily be a minimal explaining set for the DNN output.

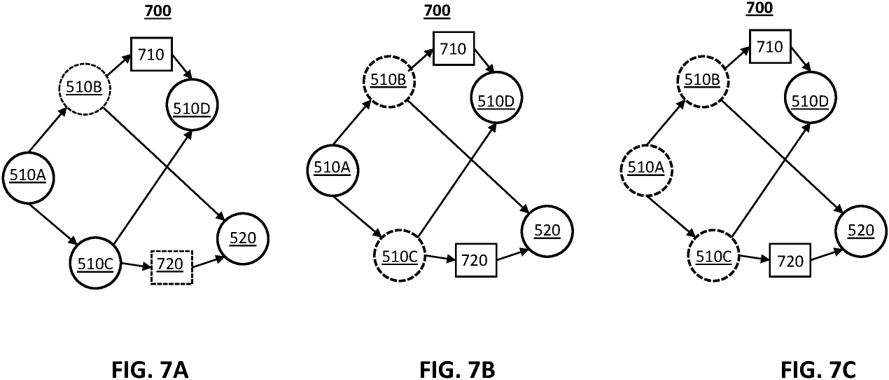

The explanation module 285 may perform an iterative procedure to identify the minimal explaining set. The explanation module 285 may create a plurality of candidate explaining sets by gradually increasing the search radius r, which may be a maximum search radius. A search within the search radius r includes search within notes at the periphery of every circle having a radius equal to or smaller than the search radius r. In some embodiments, the explanation module 285 may conduct the first iteration by identifying one or more explaining sets within the circle for the first tier. The explanation module 285 may determine if any of the identified explaining sets qualifies as a causal explanation. If all the identified explaining sets fail, the explanation module 285 may start the second iteration, in which the explanation module 285 searches within the circle for the second tier. The explanation module 285 may continue search till it determines that an identified explaining set qualifies as a causal explanation. More details about iterative search are provided below in conjunction with FIGS. 7A-7C.

The explanation module 285 may generate an explanation message based on the qualified explaining set, e.g., the minimal explaining set. The explanation message may indicate that the one or more input variables in the qualified explaining set and the DNN output has a causal relation. The explanation module 285 may include also include an alternative DNN output in the explanation message. The explanation message may indicate that the DNN would have computed the alternative output, had the minimal explaining set been absent. The explanation module 285 may send the explanation message to a user device 120 or the third-party system 130. In some embodiments, the explanation message is provided for display to the user. The explanation message may include text, audio, image, video, or other types of content.

### Example Causal Explanation Process

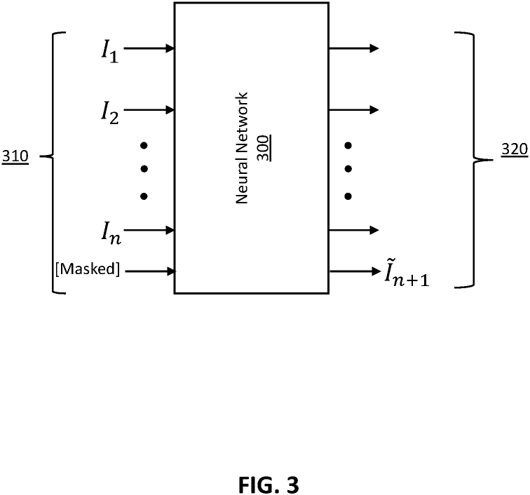

FIG. 3 illustrates an example inference of a neural network 300, in accordance with various embodiments. The inference may be performed by the inference module 240 in FIG. 2. The neural network 300 has been trained, e.g., by the training module 220. In the embodiments of FIG. 3, a session 310 is input into the neural network 300 as an input dataset of the neural network 300. The session 310 includes n variables and may be denoted as {I₁, ..., Iₙ}. The session 310 is an incomplete session as it misses a variable, which is marked. In other embodiments, there may be more than one marked variable. In embodiments where the session 310 does not miss any variable (i.e., no marked variables), the session 310 may be a complete session.

As shown in FIG. 3, the neural network 330 outputs a variable ĩₙ₊₁. The variable ĩₙ₊₁ plus the variables in the session 310 constitutes a session 320 that can be denoted as {I₁, ..., Iₙ, Ĩₙ₊₁}. The session 320 is a complete session. In some embodiments (e.g., embodiments where the output of the neural network 300 is a prediction), the session 320 may be an imagination session as it includes a variable (i.e., the variable Ĩₙ₊₁) that indicates a prediction, while the session 310 may be an actual session, and each variable in the session 310 may be actually observed.

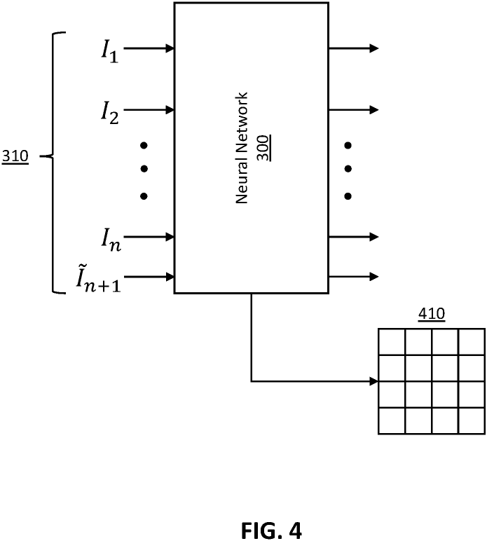

FIG. 4 illustrates an example abductive inference of the neural network 300, in accordance with various embodiments. The abductive inference may be performed by the abductive inference module 270 in FIG. 2. The abductive inference illustrated in FIG. 4 may be after the inference illustrated in FIG. 3. As shown in FIG. 4, the session 320 is input into the neural network 300. An attention matrix 410 is extracted from a hidden layer of the neural network 300. The attention matrix 410 may be computed by the hidden layer during the abductive inference. In some embodiments, the hidden layer is the last attention layer in the neural network 300, i.e., there are no other attention layers arranged after the attention layer in the neural network 300. For the purpose of illustration, the attention matrix 410 has four rows and four columns and includes 16 elements in total. In other embodiments, the attention matrix 410 may have a different spatial size, e.g., have a different number of rows or columns. Also, the attention layer may output an attention vector, a three-dimensional attention tensor, or an attention tensor of other dimensions.

FIG. 5 illustrates an example causal graph 500, in accordance with various embodiments. The causal graph 500 may be generated by the graph module 280 in FIG. 2. As shown in FIG. 5, the causal graph 500 includes four nodes 510A-510E (collectively referred to as “nodes 510” or “node 510”). In some embodiments, each of the nodes 510A-510D represents an element (e.g., a variable) in an input of a neural network, while the node 510E represents an output of the neural network. In embodiments where the neural network generates multiple outputs for a single inference process, the node 510E may indicate an output that is considered better (e.g., more accurate) than the other outputs. For instance, the confidence of the neural network in the output represented by the node 510E may be higher than the confidence of the neural network in the other outputs.

The causal graph 500 also includes connections among the nodes 510. Each connection is represented by an arrow, which may be a single direction arrow or bi-direction arrow. A connection has two nodes 510 as its end points. In some embodiments, a connection indicates a causal relation or conditional dependence between the two nodes 510. A connection may be a potential influence path or a part of a potential influence path. In an embodiment, the causal graph 500 is a partial ancestral graph. The causal graph 500 may include a different number of nodes 510 with different connections in other embodiments.

FIG. 6 illustrates an example tree structure 600, in accordance with various embodiments. The tree structure 600 may be generated based on the causal graph 500 in FIG. 5, e.g., by the graph module 280 in FIG. 2. includes the nodes 510. The node 510E is the root of the tree structure 600. The other nodes 510A-510D are arranged at peripheries of circles 610, 620, and 630. In the embodiments of FIG. 6, the node 510E is at the center of the circles 610, 620, and 630. The circles 610, 620, and 630 have gradually increasing radii. The circle 610 has the smallest radius, the circle 620 has a larger radius, and the circle 630 has the largest radius. The node 510A is at the periphery of the circle 620. The nodes 510B and 510C are at the periphery of the circle 610. There is no node at the periphery of the circle 630. The nodes 510 are connected, and the connections are represented by the arrows in FIG. 6.

The tree structure 600 may be used to search for an explanation of the output of the neural network. The searching may be done by the explanation module 285 in FIG. 2. The searching may be an interactive process. In the first iteration, the search radius is the radius of the circle 610, and a set including the node 510B and another set including the node 510C are tested to determine whether either set qualifies as an explanation. In an embodiment where either set is qualified, the searching may be terminated, and the qualified set may be used as the minimal explaining set to generate an explanation of the output of the neural network. In an embodiment where both sets fail, the second iteration can start. In the second iteration, the search radius increases to the radius of the circle 620, and a set including the nodes 510B and 510C and another set including the nodes 510A and 510C are tested. In an embodiment where either set is qualified, the searching may be terminated, and the qualified set may be used as the minimal explaining set to generate an explanation of the output of the neural network. In an embodiment where both fail, the third iteration can start. In the third iteration, the search radius is increased to the radius of the circle 630, and a set including the nodes 510A-510C may be tested. As there are no other nodes left, the set including the nodes 510A-510C is the last tested set. In embodiments where the set including the nodes 510A-510C fails and there can be one or more other sets to test, the searching may continue.

FIGS. 7A-7C illustrate example potentially influencing sets, in accordance with various embodiments. FIGS. 7A-7C each illustrates a causal graph 700, which includes the nodes 510 and connections in the causal graph 500 in FIG. 5. Additionally, the causal graph 700 includes latent nodes 710 and 720, which represent two latent variables, respectively. A latent variable may indicate a latent cofounder. FIGS. 7A-7C illustrate three different potentially influencing sets. Each potentially influencing set includes nodes marked with dash lines.

The potentially influencing set in FIG. 7A includes the node 510B and the latent node 720. As the latent node 720 represents a latent variable, the node 510B may constitute a minimal explaining set for the output of the neural network by itself. An explanation for the output of the neural network may be generated accordingly.

The potentially influencing set in FIG. 7B includes the nodes 510B and 510C, which have direct effect on the node 510E. The node 510E depends on the node 510C through the latent node 720. However, the node 510C is a collider, making the this potentially influencing set unqualified as an explanation. The potentially influencing set may be a minimum potentially influencing set. However, it does not qualify as an explanation as it includes the latent node 720.

The potentially influencing set in FIG. 7C includes the nodes 510A-510C, which have direct effect on the node 510E. Including the node 510C creates an indirect dependence between the node 510E and 510E, which is a potential influence path, which requires including the node 510A in the potentially influencing set too.

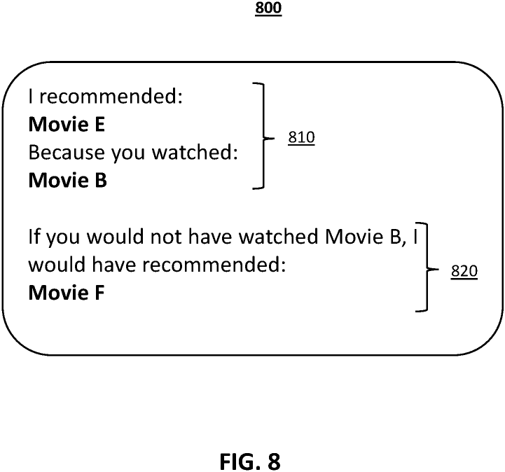

FIG. 8 illustrates an example explanation 800 of a neural network output, in accordance with various embodiments. The explanation 800 may be generated, e.g., by the explanation module 285 in FIG. 2, based on the minimal explaining set in FIG. 7A. For the purpose of illustration, the neural network output in the embodiments of FIG. 8 is a recommendation of a movie to a user. The node 510E may represent a predicted interaction of the user with the recommendation movie, e.g., a prediction of the user watching the movie. Each of the nodes 510A-510E may represent an actual interaction of the user with a movie. Different nodes 510 may be for different movies.

As shown in FIG. 8, the explanation 800 includes two parts 810 and 820. The part 810 provides that the recommended movie is Movie E. The part 810 also provide the reasons why the recommendation was made “because you watched” Movie B.” “I” refers to the neural network, and “you” refers to the user. The part 810 indicates that there is a causal relation between the user watching Movie B and the neural network recommending Movie E to the user.

The part 820 provides an alternative recommendation to the user, i.e., Movie F. The part 820 indicates that the neural network would have recommended Movie E if the user would not have watched Movie B. In some embodiments, the input element corresponding to the user’s interaction with Movie B is removed from the input dataset to generate a new input dataset. The new input dataset is used for an inference of the neural network, e.g., by the inference module 240. The neural network outputs a predicted interaction of the user with Movie F and therefore, recommends Movie F absent the removed input element. For the purpose of illustration, the explanation 800 is text. In other embodiments, the explanation may include image, video, audio, text, number, symbol, or some combination thereof.

### Example Method of Causal Explanation

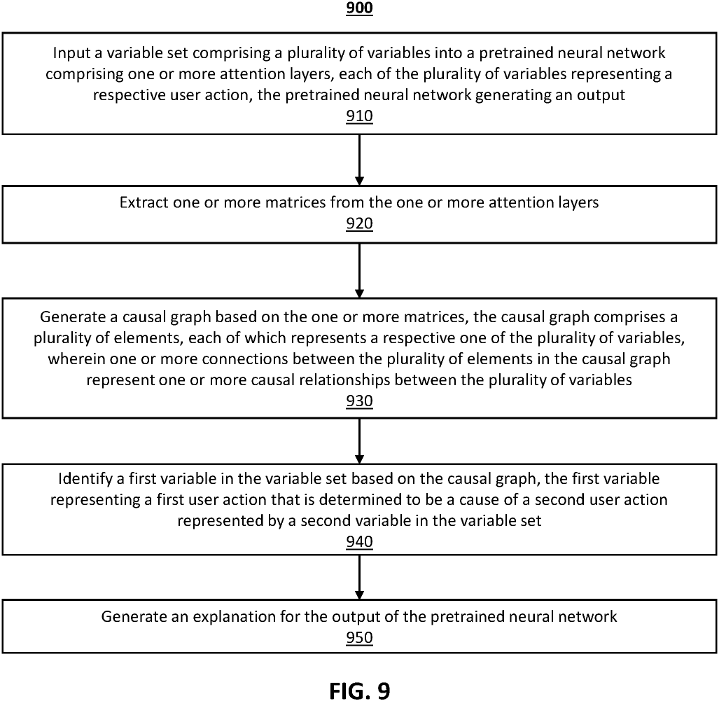

FIG. 9 is a flowchart showing a method 900 of solving a conic optimization problem, in accordance with various embodiments. The method 900 may be performed by the conic optimization module 140 in FIGS. 1 and 2. Although the method 900 is described with reference to the flowchart illustrated in FIG. 9, many other methods for solving conic optimization problems may alternatively be used. For example, the order of execution of the steps in FIG. 9 may be changed. As another example, some of the steps may be changed, eliminated, or combined.

The causal explanation module 260 inputs 910 a variable set comprising a plurality of variables into a pretrained neural network comprising one or more attention layers. Each of the plurality of variables represents a respective user action. The pretrained neural network generating an output. In some embodiments, the causal explanation module 260 inputs an initial variable set into the pretrained neural network. The initial variable set comprises one or more variables that include a first variable. The pretrained neural network outputs the second variable. In some embodiments, the one or more variables represent one or more historical user actions, and the second variable represents a predicted user action.

The causal explanation module 260 extracts 920 one or more matrices from the one or more attention layers.

The causal explanation module 260 generates 930 a causal graph based on the one or more matrices. The causal graph comprises a plurality of elements, each of which represents a respective one of the plurality of variables. One or more connections between the plurality of elements in the causal graph represent one or more causal relationships between the plurality of variables. In some embodiments, the causal explanation module 260 measures conditional independence between the plurality of variables based on the one or more matrices. The causal explanation module 260 determines the one or more connections in the causal graph based on the conditional independence between the plurality of variables.

The causal explanation module 260 identifies 940 the first variable in the variable set based on the causal graph. The first variable represents the first user action that is determined to be a cause of a second user action represented by the second variable in the variable set. In some embodiments, the causal explanation module 260 generates a tree structure comprising the plurality of elements based on the causal graph. The causal explanation module 260 arranges an element representing the second variable as a root of the tree. The causal explanation module 260 arranges other elements of the plurality of elements around the root of the tree based on the one or more causal relationships between the plurality of variables. In some embodiments, the causal explanation module 260 divides the other elements into a plurality of groups based on distances from each of the other elements to the root of the tree, each group comprising one or more of the other elements. The causal explanation module 260 searches for the first variable in each of the plurality of groups based on a sequence in accordance with the distances.

The causal explanation module 260 generates 950 an explanation for the output of the pretrained neural network. In some embodiments, the second user action is a predicted interaction of a user with an item. The output of the pretrained neural network comprises a recommendation of the item to the user. In an embodiment, the explanation indicates that the first user action is a reason for the recommendation. In some embodiments, the output of the pretrained neural network is a group of recommendations that includes the recommendation and one or more other recommendations. The recommendation is selected based on a ranking of the group of recommendations.

In some embodiments, the causal explanation module 260 forms a new variable set that comprises the one or more variables other than the first variable. The causal explanation module 260 inputs the new variable set into the pretrained neural network. The pretrained neural network outputs a different recommendation. The explanation further indicates that the different recommendation would have been made if the first user action represented by the first variable was not performed.

### Example Computing Device

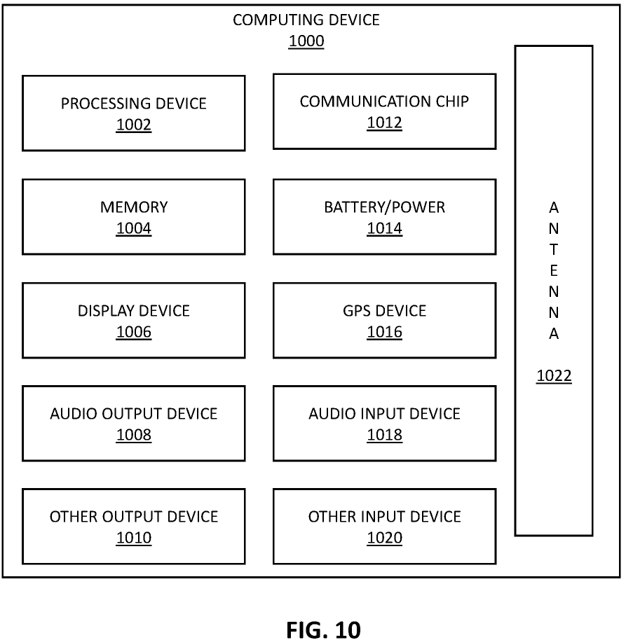

FIG. 10 is a block diagram of an example computing device 1000, in accordance with various embodiments. In some embodiments, the computing device 1000 may be used for at least part of the neural network system 110 in FIG. 1. A number of components are illustrated in FIG. 10 as included in the computing device 1000, but any one or more of these components may be omitted or duplicated, as suitable for the application. In some embodiments, some or all of the components included in the computing device 1000 may be attached to one or more motherboards. In some embodiments, some or all of these components are fabricated onto a single system on a chip (SoC) die. Additionally, in various embodiments, the computing device 1000 may not include one or more of the components illustrated in FIG. 10, but the computing device 1000 may include interface circuitry for coupling to the one or more components. For example, the computing device 1000 may not include a display device 1006, but may include display device interface circuitry (e.g., a connector and driver circuitry) to which a display device 1006 may be coupled. In another set of examples, the computing device 1000 may not include an audio input device 1018 or an audio output device 1008, but may include audio input or output device interface circuitry (e.g., connectors and supporting circuitry) to which an audio input device 1018 or audio output device 1008 may be coupled.

The computing device 1000 may include a processing device 1002 (e.g., one or more processing devices). The processing device 1002 processes electronic data from registers and/or memory to transform that electronic data into other electronic data that may be stored in registers and/or memory. The computing device 1000 may include a memory 1004, which may itself include one or more memory devices such as volatile memory (e.g., DRAM), nonvolatile memory (e.g., read-only memory (ROM)), high bandwidth memory (HBM), flash memory, solid state memory, and/or a hard drive. In some embodiments, the memory 1004 may include memory that shares a die with the processing device 1002. In some embodiments, the memory 1004 includes one or more non-transitory computer-readable media storing instructions executable for occupancy mapping or collision detection, e.g., the method 900 described above in conjunction with FIG. 9 or some operations performed by the neural network system 110 or the causal explanation module 260. The instructions stored in the one or more non-transitory computer-readable media may be executed by the processing device 1002.

In some embodiments, the computing device 1000 may include a communication chip 1012 (e.g., one or more communication chips). For example, the communication chip 1012 may be configured for managing wireless communications for the transfer of data to and from the computing device 1000. The term “wireless” and its derivatives may be used to describe circuits, devices, systems, methods, techniques, communications channels, etc., that may communicate data using modulated electromagnetic radiation through a nonsolid medium. The term does not imply that the associated devices do not contain any wires, although in some embodiments they might not.

The communication chip 1012 may implement any of a number of wireless standards or protocols, including but not limited to Institute for Electrical and Electronic Engineers (IEEE) standards including Wi-Fi (IEEE 802.10 family), IEEE 802.16 standards (e.g., IEEE 802.16-2005 Amendment), Long-Term Evolution (LTE) project along with any amendments, updates, and/or revisions (e.g., advanced LTE project, ultramobile broadband (UMB) project (also referred to as “3GPP2”), etc.). IEEE 802.16 compatible Broadband Wireless Access (BWA) networks are generally referred to as WiMAX networks, an acronym that stands for worldwide interoperability for microwave access, which is a certification mark for products that pass conformity and interoperability tests for the IEEE 802.16 standards. The communication chip 1012 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication chip 1012 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication chip 1012 may operate in accordance with CDMA, Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication chip 1012 may operate in accordance with other wireless protocols in other embodiments. The computing device 1000 may include an antenna 1022 to facilitate wireless communications and/or to receive other wireless communications (such as AM or FM radio transmissions).

In some embodiments, the communication chip 1012 may manage wired communications, such as electrical, optical, or any other suitable communication protocols (e.g., the Ethernet). As noted above, the communication chip 1012 may include multiple communication chips. For instance, a first communication chip 1012 may be dedicated to shorter-range wireless communications such as Wi-Fi or Bluetooth, and a second communication chip 1012 may be dedicated to longer-range wireless communications such as global positioning system (GPS), EDGE, GPRS, CDMA, WiMAX, LTE, EV-DO, or others. In some embodiments, a first communication chip 1012 may be dedicated to wireless communications, and a second communication chip 1012 may be dedicated to wired communications.

The computing device 1000 may include battery/power circuitry 1014. The battery/power circuitry 1014 may include one or more energy storage devices (e.g., batteries or capacitors) and/or circuitry for coupling components of the computing device 1000 to an energy source separate from the computing device 1000 (e.g., AC line power).

The computing device 1000 may include a display device 1006 (or corresponding interface circuitry, as discussed above). The display device 1006 may include any visual indicators, such as a heads-up display, a computer monitor, a projector, a touchscreen display, a liquid crystal display (LCD), a light-emitting diode display, or a flat panel display, for example.

The computing device 1000 may include an audio output device 1008 (or corresponding interface circuitry, as discussed above). The audio output device 1008 may include any device that generates an audible indicator, such as speakers, headsets, or earbuds, for example.

The computing device 1000 may include an audio input device 1018 (or corresponding interface circuitry, as discussed above). The audio input device 1018 may include any device that generates a signal representative of a sound, such as microphones, microphone arrays, or digital instruments (e.g., instruments having a musical instrument digital interface (MIDI) output).

The computing device 1000 may include a GPS device 1016 (or corresponding interface circuitry, as discussed above). The GPS device 1016 may be in communication with a satellite-based system and may receive a location of the computing device 1000, as known in the art.

The computing device 1000 may include another output device 1010 (or corresponding interface circuitry, as discussed above). Examples of the other output device 1010 may include an audio codec, a video codec, a printer, a wired or wireless transmitter for providing information to other devices, or an additional storage device.

The computing device 1000 may include another input device 1020 (or corresponding interface circuitry, as discussed above). Examples of the other input device 1020 may include an accelerometer, a gyroscope, a compass, an image capture device, a keyboard, a cursor control device such as a mouse, a stylus, a touchpad, a bar code reader, a Quick Response (QR) code reader, any sensor, or a radio frequency identification (RFID) reader.

The computing device 1000 may have any desired form factor, such as a handheld or mobile computer system (e.g., a cell phone, a smart phone, a mobile internet device, a music player, a tablet computer, a laptop computer, a netbook computer, an ultrabook computer, a PDA, an ultramobile personal computer, etc.), a desktop computer system, a server or other networked computing component, a printer, a scanner, a monitor, a set-top box, an entertainment control unit, a vehicle control unit, a digital camera, a digital video recorder, or a wearable computer system. In some embodiments, the computing device 1000 may be any other electronic device that processes data.

### Selected Examples

The following paragraphs provide various examples of the embodiments disclosed herein.

Example 1 provides a computer-implemented method, including inputting a variable set including a plurality of variables into a pretrained neural network including one or more attention layers, each of the plurality of variables representing a respective user action, the pretrained neural network generating an output; extracting one or more matrices from the one or more attention layers; generating a causal graph based on the one or more matrices, the causal graph includes a plurality of elements, each of which represents a respective one of the plurality of variables, where one or more connections between the plurality of elements in the causal graph represent one or more causal relationships between the plurality of variables; identifying a first variable in the variable set based on the causal graph, the first variable representing a first user action that is determined to be a cause of a second user action represented by a second variable in the variable set; and generating an explanation for the output of the pretrained neural network.

Example 2 provides the computer-implemented method of example 1, further including inputting an initial variable set into the pretrained neural network, the initial variable set including one or more variables that include the first variable, the pretrained neural network outputting the second variable; and forming the variable set that includes the one or more variables and the second variable.

Example 3 provides the computer-implemented method of example 2, where the one or more variables represent one or more historical actions of a user, and the second user action represented by the second variable is a predicted action of the user.

Example 4 provides the computer-implemented method of any of the preceding examples, where the second user action is a predicted interaction of a user with an item, and the output of the pretrained neural network includes a recommendation of the item to the user.

Example 5 provides the computer-implemented method of example 4, where the output of the pretrained neural network is a group of recommendations that includes the recommendation and one or more other recommendations, and the recommendation is selected based on a ranking of the group of recommendations.

Example 6 provides the computer-implemented method of example 4 or 5, where the explanation indicates that the first user action is a reason for the recommendation.

Example 7 provides the computer-implemented method of example 6, further including forming a new variable set that includes the one or more variables other than the first variable; and inputting the new variable set into the pretrained neural network, the pretrained neural network outputting a different recommendation, where the explanation further indicates that the different recommendation would have been made if the first user action represented by the first variable was not performed.

Example 8 provides the computer-implemented method of any of the preceding examples, where generating the causal graph based on the one or more matrices includes measuring conditional independence between the plurality of variables based on the one or more matrices; and determining the one or more connections in the causal graph based on the conditional independence between the plurality of variables.

Example 9 provides the computer-implemented method of any of the preceding examples, where identifying the first variable in the variable set based on the causal graph includes generating a tree structure including the plurality of elements based on the causal graph by arranging an element representing the second variable as a root of the tree; and arranging other elements of the plurality of elements around the root of the tree based on the one or more causal relationships between the plurality of variables.

Example 10 provides the computer-implemented method of example 9, where identifying the first variable in the variable set based on the causal graph further includes dividing the other elements into a plurality of groups based on distances from each of the other elements to the root of the tree, each group including one or more of the other elements; and searching for the first variable in each of the plurality of groups based on a sequence in accordance with the distances.

Example 11 provides one or more non-transitory computer-readable media storing instructions executable to perform operations, the operations including inputting a variable set including a plurality of variables into a pretrained neural network including one or more attention layers, each of the plurality of variables representing a respective user action, the pretrained neural network generating an output; extracting one or more matrices from the one or more attention layers; generating a causal graph based on the one or more matrices, the causal graph including a plurality of elements, each of which represents a respective one of the plurality of variables, where one or more connections between the plurality of elements in the causal graph represent one or more causal relationships between the plurality of variables; identifying a first variable in the variable set based on the causal graph, the first variable representing a first user action that is determined to be a cause of a second user action represented by a second variable in the variable set; and generating an explanation for the output of the pretrained neural network.

Example 12 provides the one or more non-transitory computer-readable media of example 11, where the operations further include inputting an initial variable set into the pretrained neural network, the initial variable set including one or more variables that include the first variable, the pretrained neural network outputting the second variable; and forming the variable set that includes the one or more variables and the second variable.

Example 13 provides the one or more non-transitory computer-readable media of example 11 or 12, where the second user action is a predicted interaction of a user with an item, the output of the pretrained neural network includes a recommendation of the item to the user, and the explanation indicates that the first user action is a reason for the recommendation.

Example 14 provides the one or more non-transitory computer-readable media of any one of examples 11-13, where generating the causal graph based on the one or more matrices includes measuring conditional independence between the plurality of variables based on the one or more matrices; and determining the one or more connections in the causal graph based on the conditional independence between the plurality of variables.

Example 15 provides the one or more non-transitory computer-readable media of any one of examples 11-14, where identifying the first variable in the variable set based on the causal graph includes generating a tree structure including the plurality of elements based on the causal graph by arranging an element representing the second variable as a root of the tree; and arranging other elements of the plurality of elements around the root of the tree based on the one or more causal relationships between the plurality of variables.

Example 16 provides an apparatus, including a computer processor for executing computer program instructions; and a non-transitory computer-readable memory storing computer program instructions executable by the computer processor to perform operations including inputting a variable set including a plurality of variables into a pretrained neural network including one or more attention layers, each of the plurality of variables representing a respective user action, the pretrained neural network generating an output, extracting one or more matrices from the one or more attention layers, generating a causal graph based on the one or more matrices, the causal graph including a plurality of elements, each of which represents a respective one of the plurality of variables, where one or more connections between the plurality of elements in the causal graph represent one or more causal relationships between the plurality of variables, identifying a first variable in the variable set based on the causal graph, the first variable representing a first user action that is determined to be a cause of a second user action represented by a second variable in the variable set, and generating an explanation for the output of the pretrained neural network.

Example 17 provides the apparatus of example 16, where the operations further include inputting an initial variable set into the pretrained neural network, the initial variable set including one or more variables that include the first variable, the pretrained neural network outputting the second variable; and forming the variable set that includes the one or more variables and the second variable.

Example 18 provides the apparatus of example 16 or 17, where the second user action is a predicted interaction of a user with an item, the output of the pretrained neural network includes a recommendation of the item to the user, and the explanation indicates that the first user action is a reason for the recommendation.

Example 19 provides the apparatus of any one of examples 16-18, where generating the causal graph based on the one or more matrices includes measuring conditional independence between the plurality of variables based on the one or more matrices; and determining the one or more connections in the causal graph based on the conditional independence between the plurality of variables.

Example 20 provides the apparatus of any one of examples 16-19, where identifying the first variable in the variable set based on the causal graph includes generating a tree structure including the plurality of elements based on the causal graph by arranging an element representing the second variable as a root of the tree; and arranging other elements of the plurality of elements around the root of the tree based on the one or more causal relationships between the plurality of variables.

The above description of illustrated implementations of the disclosure, including what is described in the Abstract, is not intended to be exhaustive or to limit the disclosure to the precise forms disclosed. While specific implementations of, and examples for, the disclosure are described herein for illustrative purposes, various equivalent modifications are possible within the scope of the disclosure, as those skilled in the relevant art will recognize. These modifications may be made to the disclosure in light of the above detailed description.

1. A computer-implemented method, comprising:
inputting a variable set comprising a plurality of variables into a pretrained neural network comprising one or more attention layers, each of the plurality of variables representing a respective user action, the pretrained neural network generating an output;
extracting one or more matrices from the one or more attention layers;
generating a causal graph based on the one or more matrices, the causal graph comprising a plurality of elements, each of which represents a respective one of the plurality of variables, wherein one or more connections between the plurality of elements in the causal graph represent one or more causal relationships between the plurality of variables;
identifying a first variable in the variable set based on the causal graph, the first variable representing a first user action that is determined to be a cause of a second user action represented by a second variable in the variable set; and
generating an explanation for the output of the pretrained neural network.

2. The computer-implemented method of claim 1, further comprising:
inputting an initial variable set into the pretrained neural network, the initial variable set comprising one or more variables that include the first variable, the pretrained neural network outputting the second variable; and
forming the variable set that includes the one or more variables and the second variable.

3. The computer-implemented method of claim 2, wherein the one or more variables represent one or more historical actions of a user, and the second user action represented by the second variable is a predicted action of the user.

4. The computer-implemented method of claim 1, wherein the second user action is a predicted interaction of a user with an item, and the output of the pretrained neural network comprises a recommendation of the item to the user.

5. The computer-implemented method of claim 4, wherein the output of the pretrained neural network is a group of recommendations that includes the recommendation and one or more other recommendations, and the recommendation is selected based on a ranking of the group of recommendations.

6. The computer-implemented method of claim 4, wherein the explanation indicates that the first user action is a reason for the recommendation.

7. The computer-implemented method of claim 6, further comprising:
forming a new variable set that comprises the one or more variables other than the first variable; and
inputting the new variable set into the pretrained neural network, the pretrained neural network outputting a different recommendation,
wherein the explanation further indicates that the different recommendation would have been made if the first user action represented by the first variable was not performed.

8. The computer-implemented method of claim 1, wherein generating the causal graph based on the one or more matrices comprises:
measuring conditional independence between the plurality of variables based on the one or more matrices; and
determining the one or more connections in the causal graph based on the conditional independence between the plurality of variables.

9. The computer-implemented method of claim 1, wherein identifying the first variable in the variable set based on the causal graph comprises generating a tree structure comprising the plurality of elements based on the causal graph by:
arranging an element representing the second variable as a root of the tree; and
arranging other elements of the plurality of elements around the root of the tree based on the one or more causal relationships between the plurality of variables.

10. The computer-implemented method of claim 9, wherein identifying the first variable in the variable set based on the causal graph further comprises:
dividing the other elements into a plurality of groups based on distances from each of the other elements to the root of the tree, each group comprising one or more of the other elements; and
searching for the first variable in each of the plurality of groups based on a sequence in accordance with the distances.

11. One or more non-transitory computer-readable media storing instructions executable to perform operations, the operations comprising:
inputting a variable set comprising a plurality of variables into a pretrained neural network comprising one or more attention layers, each of the plurality of variables representing a respective user action, the pretrained neural network generating an output;
extracting one or more matrices from the one or more attention layers;
generating a causal graph based on the one or more matrices, the causal graph comprising a plurality of elements, each of which represents a respective one of the plurality of variables, wherein one or more connections between the plurality of elements in the causal graph represent one or more causal relationships between the plurality of variables;
identifying a first variable in the variable set based on the causal graph, the first variable representing a first user action that is determined to be a cause of a second user action represented by a second variable in the variable set; and
generating an explanation for the output of the pretrained neural network.

12. The one or more non-transitory computer-readable media of claim 11, wherein the operations further comprise:
inputting an initial variable set into the pretrained neural network, the initial variable set comprising one or more variables that include the first variable, the pretrained neural network outputting the second variable; and
forming the variable set that includes the one or more variables and the second variable.

13. The one or more non-transitory computer-readable media of claim 11, wherein the second user action is a predicted interaction of a user with an item, the output of the pretrained neural network comprises a recommendation of the item to the user, and the explanation indicates that the first user action is a reason for the recommendation.

14. The one or more non-transitory computer-readable media of claim 11, wherein generating the causal graph based on the one or more matrices comprises:
measuring conditional independence between the plurality of variables based on the one or more matrices; and
determining the one or more connections in the causal graph based on the conditional independence between the plurality of variables.

15. The one or more non-transitory computer-readable media of claim 11, wherein identifying the first variable in the variable set based on the causal graph comprises generating a tree structure comprising the plurality of elements based on the causal graph by:
arranging an element representing the second variable as a root of the tree; and arranging other elements of the plurality of elements around the root of the tree based on the one or more causal relationships between the plurality of variables.

16. An apparatus, comprising:
a computer processor for executing computer program instructions; and
a non-transitory computer-readable memory storing computer program instructions executable by the computer processor to perform operations comprising:
inputting a variable set comprising a plurality of variables into a pretrained neural network comprising one or more attention layers, each of the plurality of variables representing a respective user action, the pretrained neural network generating an output,
extracting one or more matrices from the one or more attention layers,
generating a causal graph based on the one or more matrices, the causal graph comprising a plurality of elements, each of which represents a respective one of the plurality of variables, wherein one or more connections between the plurality of elements in the causal graph represent one or more causal relationships between the plurality of variables,
identifying a first variable in the variable set based on the causal graph, the first variable representing a first user action that is determined to be a cause of a second user action represented by a second variable in the variable set, and
generating an explanation for the output of the pretrained neural network.

17. The apparatus of claim 16, wherein the operations further comprise:
inputting an initial variable set into the pretrained neural network, the initial variable set comprising one or more variables that include the first variable, the pretrained neural network outputting the second variable; and
forming the variable set that includes the one or more variables and the second variable.

18. The apparatus of claim 16, wherein the second user action is a predicted interaction of a user with an item, the output of the pretrained neural network comprises a recommendation of the item to the user, and the explanation indicates that the first user action is a reason for the recommendation.

19. The apparatus of claim 16, wherein generating the causal graph based on the one or more matrices comprises:
measuring conditional independence between the plurality of variables based on the one or more matrices; and
determining the one or more connections in the causal graph based on the conditional independence between the plurality of variables.

20. The apparatus of claim 16, wherein identifying the first variable in the variable set based on the causal graph comprises generating a tree structure comprising the plurality of elements based on the causal graph by:
arranging an element representing the second variable as a root of the tree; and
arranging other elements of the plurality of elements around the root of the tree based on the one or more causal relationships between the plurality of variables.
